(19) United States
(12) Patent Application Publication
(10) Pub. No.: US 2015/0337071 A1
(43) Pub. Date: Nov. 26, 2015

(54) POLYURETHANE FOAM PANEL

(71) Applicant: TOYO TIRE & RUBBER CO., LTD., Osaka (JP)

(72) Inventors: Tsuguo WATANABE, Osaka (JP); Jun AKAI, Osaka (JP)

(73) Assignee: TOYO TIRE & RUBBER CO., LTD., Osaka-shi, Osaka (JP)

(21) Appl. No.: 14/759,183

(22) PCT Filed: Dec. 20, 2013
(86) PCT No.: PCT/JP2013/084332

§ 371 Date: Jul. 2, 2015

(30) Foreign Application Priority Data
Jan. 9, 2013 (JP) 2013-001991

(51) Int. Cl. C08G 18/06; E04B 1/80

(52) U.S. Cl. CPC C08G 18/06; E04B 1/80; C08G 2101/0083

(57) ABSTRACT

A polyurethane foam panel which is obtained by mixing a polyol composition comprising a polyol compound and a water as a foaming agent with a polyisocyanate component, and causing these components to react with each other, and which has a lengthwise direction, a widthwise direction, and a thickness direction, wherein the foam density is 15 kg/m³ or less, and the ratio of the 10% compressive strength Sa in the lengthwise direction to the 10% compressive strength Sb in the widthwise direction (Sa/Sb) is 2 or more.

### TECHNICAL FIELD

The present invention relates to a polyurethane foam panel which is obtained by mixing a polyol composition containing a polyol compound and a water as a foaming agent with a polyisocyanate component, and causing these components to react with each other, and which has a lengthwise direction, a widthwise direction, and a thickness direction.

### BACKGROUND ART

Hitherto, glass wool has widely been used as a heat insulating material for buildings such as detached housings. Glass wool is not necessarily sufficient in heat insulating performance. However, the reason why this material is widely used would be that the material is inexpensive. In the meantime, a polyurethane foam panel is better in heat insulating performance than glass wool; however, the panel is not used more widely than glass wool. Reasons therefor would, for example, as follows: the panel is expensive; it is difficult to lower the polyurethane foam panel in density while the heat insulating performance thereof is maintained; or costs are high for transporting polyurethane foam panels produced in a factory or some other to a construction site such as a house.

As a technique for using a polyurethane foam panel as a heat insulating member, Patent Document 1 listed below discloses a heat insulating construction method for making heat insulating members thin to decrease the use amount thereof and costs therefor, the method being a method of applying, to a building, the members that are heat insulating members made mainly of a hard polyurethane foam having a thermoconductivity of 0.020 W/mK or less.

Furthermore, Patent Document 2 listed below states that a low-density hard polyurethane foam having a core density of 2 to 20 kg/m³ both inclusive is produced by a spraying method using, as a raw material, a polyol composition including a polyoxyalkylene polyether polyol having a number-average molecular weight of 2000 to 9000 and a polyoxyalkylene polyether polyol having a number-average molecular weight of 250 to 750, considering that costs for transportation to a construction site can be decreased and the foam is better in fillability into spaces between internal or external walls than glass wool.

### PRIOR ART DOCUMENTS

### Patent Documents

Patent Document 1: JP-A-2003-278290

Patent Document 2: JP-A-2002-293868

### SUMMARY OF THE INVENTION

### Problems to be Solved by the Invention

However, each of the precedent techniques has problems as described in the following: Although the hard polyurethane foam used in the technique described in Patent Document 1 is excellent in heat insulating performance, the foam is high in density and further poor in softness/flexibility; thus, when the hard polyurethane foam is fitted into between frames, the foam is low in shape flexibility to have a problem about the workability thereof. According to the technique described in

Patent Document 2, a hard polyurethane foam is produced by a spraying method; it is therefore important that the foam is low in restorability ratio, and thus the foam is poor in softness/flexibility.

In light of the above-mentioned actual circumstances, the present invention has been made. An object thereof is to provide a polyurethane foam panel which is low in density, and has softness/flexibility and an anisotropy in foam strength, and which is useful as a heat insulating member for buildings such as a detached building.

### Means for Solving the Problems

The object can be attained by the present invention described in the following: the present invention is a polyurethane foam panel which is obtained by mixing a polyol composition comprising a polyol compound and a water as a foaming agent with a polyisocyanate component, and causing these components to react with each other, and which has a lengthwise direction, a widthwise direction, and a thickness direction, wherein the foam density is 15 kg/m³ or less, and the ratio of the 10% compressive strength Sa in the lengthwise direction to the 10% compressive strength Sb in the widthwise direction (Sa/Sb) is 2 or more.

About the polyurethane foam panel according to the present invention, the foam density is 15 kg/m³ or less. Thus, the foam density is very low so that in a foaming step into the foam, the foaming expansion ratio becomes large. As a result, cells (air bubbles) in a foam of the panel are stretched into a foaming direction (vertical direction) of the foam so that substantially elliptical in-foam cells are formed. In such a case, the polyurethane foam panel is cut to render the vertical direction the lengthwise direction of the panel. This manner makes it possible to yield a polyurethane foam panel having elliptical in-foam cells each having a long diameter in the lengthwise direction. The elliptical in-foam cells are each arranged to have the long diameter in a substantially lengthwise direction of the polyurethane foam panel; according to this matter, the polyurethane foam panel is made high in foam strength in the lengthwise direction while low in foam strength in the widthwise direction, and further the panel has softness/flexibility in the widthwise direction. As a result, about the polyurethane foam panel according to the present invention, the ratio of the 10% compressive strength Sa in the lengthwise direction to the 10% compressive strength Sb in the widthwise direction (Sa/Sb) becomes 2 or more.

In a case where, at the time of using a polyurethane foam panel as a heat insulating member for a building, a gap is present between frames after this panel is fitted to between the frames, the building is deteriorated in heat insulating performance. Although any conventional hard polyurethane foam panel has an excellent heat insulating performance, the panel tends to be hard and brittle. It is therefore necessary to cut the polyurethane foam panel to have a size consistent with the size between the frames. Thus, the panel is not good in workability. However, the polyurethane foam panel according to the present invention is soft/flexible in the widthwise direction to have softness/flexibility, and further has strength in the lengthwise direction to have self-standing property. Thus, when the polyurethane foam panel is cut into a widthwise size slightly larger than that between frames and then this cut panel is fitted to between the frames while compressed in the widthwise direction, the polyurethane foam panel is fittable thereto without generating any gap between the frames. Accordingly, the polyurethane foam panel according to the present invention is particularly useful as a heating insulating member to be applied to between frames for buildings.

In the polyurethane foam panel, the 10% compressive strength Sb in the widthwise direction is preferably 3 N/cm² or less. According to this structure, the polyurethane foam panel is sufficiently soft/flexible in the widthwise direction, and is improved in workability when fitted into between frames while compressed into the widthwise direction.

In the polyurethane foam panel, it is preferred that the thickness direction of this panel is substantially perpendicular to a foaming direction of the cells in the foam. As described above, the polyurethane foam panel according to the present invention is low in density, and the in-foam cells are each in a substantially elliptical form and are connected to each other so that the cells have a high continuous cell proportion. When in such a case the thickness direction of the polyurethane foam panel is substantially perpendicular to the foaming direction of the in-foam cells, the shift of heat can be restrained in the panel in the thickness direction. Accordingly, when the polyurethane foam panel is arranged into a building such as a detached house, the building is heightened in heat insulating performance, in particular, in the thickness direction.

### BRIEF DESCRIPTION OF THE DRAWINGS

FIG. 1A and 1B are views illustrating an example of the polyurethane foam panel according to the present invention.

FIG. 2 is a view illustrating an example of a method for producing the polyurethane foam panel according to the present invention.

FIG. 3 is a view illustrating an example of a conventional method for producing a polyurethane foam panel.

### MODE FOR CARRYING OUT THE INVENTION

The polyurethane foam panel according to the present invention is a polyurethane foam panel which is obtained by mixing a polyol composition containing a polyol compound and a water as a foaming agent with a polyisocyanate component, and causing these components to react with each other, and which has a lengthwise direction, a widthwise direction, and a thickness direction, wherein the foam density is 15 kg/m³ or less, and the ratio of the 10% compressive strength Sa in the lengthwise direction to the 10% compressive strength Sb in the widthwise direction (Sa/Sb) is 2 or more.

The foam density (core density) of the polyurethane foam panel according to the present invention is preferably 15 kg/m³ or less, more preferably 13 kg/m³ or less, even more preferably 11 kg/m³ or less. This foam density can be set into the range, for example, by adjusting the amount of water as the foaming agent into the range of 20 to 100 parts by weight (for 100 parts by weight of the polyol compound). The foam density herein is a value measured in accordance with JIS K7222.

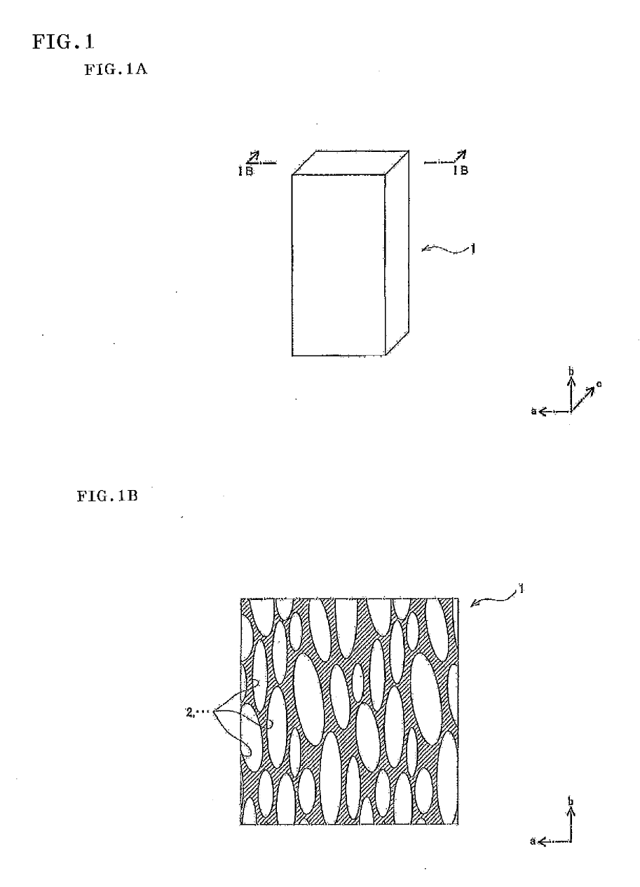

The polyurethane foam panel according to the present invention has a shape having a lengthwise direction, a widthwise direction and a thickness direction, for example, a rectangular parallelepiped, cubic, or parallelepiped shape. FIG. 1A illustrates an example of the polyurethane foam panel according to the present invention. In the present embodiment, as an example, given is a rectangular parallelepiped in which the lengthwise direction “b” is longer than the widthwise direction “a”. This example will be described. However, in the present invention, the widthwise direction “a” may be longer than the lengthwise direction “b”.

FIG. 1B illustrates a sectional view (enlarged view) taken on line IB-IB of the polyurethane foam panel illustrated in FIG. 1A. This polyurethane foam panel, which is a panel 1, has a foam density of 15 kg/m³ or less, and is very low in foam density and high in foaming expansion ratio. Thus, in-foam cells 2 are stretched in the lengthwise direction “b” to be formed as substantially elliptical in-foam cells. The long diameter direction of the elliptical in-foam cells 2 is made parallel with substantially the lengthwise direction. This makes the polyurethane foam panel 1 high in foam strength in the lengthwise direction “b” and makes the panel 1 low in foam strength in the widthwise direction “a”, and further makes the panel 1 soft/flexible in the widthwise direction “a”.

About the polyurethane foam panel according to the present invention, the ratio of the 10% compressive strength Sa in the lengthwise direction to the 10% compressive strength

Sb in the widthwise direction (Sa/Sb) is 2 or more. The ratio of the 10% compressive strength Sa in the lengthwise direction to that Sb in the widthwise direction (Sa/Sb) is preferably 3 or more, more preferably 5 or more to make the polyurethane foam panel compatible between workability when the panel is fitted into between frames and self-standing property after the fitting. The upper limit of the ratio Sa/Sb is not particularly limited, and is, for example, about 7.

In order to fit the polyurethane foam panel to between frames while the panel is compressed in the widthwise direction, it is preferred that the panel has softness/flexibility in the widthwise direction. In order that the polyurethane foam panel can ensure softness/flexibility, in particular, in the widthwise direction, the 10% compressive strength Sb of the panel in the widthwise direction is preferably 3 N/cm² or less, more preferably 1 N/cm² or less, in particular preferably 0.5 N/cm² or less.

When the polyurethane foam panel is fitted to between frames while compressed into the widthwise direction, it is important for embedding the panel into between the frames without generating any gap that the panel has restorability as well as softness/flexibility. From this viewpoint, it is preferred that the polyurethane foam panel is not broken when compressed by 20% into the widthwise direction, and when released after the 20% compression, the panel is restored up to 90% or more of the widthwise direction length of the panel before the compression.

In the polyurethane foam panel according to the present invention, it is preferred that the thickness direction of the polyurethane foam panel is substantially perpendicular to the foaming direction of the in-foam cells. In the present invention, the wording “substantially perpendicular” specifically denotes 90°±15°, in particular, 90°±10°. Such a wording as “foaming direction of the in-foam cells” denotes the following when the shape of the individual cells is regarded as an elliptical shape: the long diameter direction of the cells. The wording denotes, in particular, the direction obtained in the case of measuring a central region of the polyurethane foam panel (region extended from the center of the panel in the widthwise direction and the lengthwise direction to both sides thereof along the former direction by 10% of the width, as well as to both sides thereof along the latter direction by 10% of the length.

Since the polyurethane foam panel according to the present invention is used as a heating insulating member, the panel is required to have heat insulating performance. About the heat insulating performance of the polyurethane foam panel, the thermoconductivity λ thereof is 0.04 W/m·K, or less. In this case, even when this polyurethane foam panel is a panel made low in density, the panel can exhibit a sufficient heat insulating performance. The thermoconductivity herein is a value measured in accordance with JIS A1412-2.

About the polyurethane foam panel obtained by the production method, the independent cell proportion is preferably 15% or less, more preferably from 0 to 10%. When the polyurethane foam panel is made high in continuous cell proportion in this way, the panel can ensure an excellent dimension stability. The independent cell proportion herein is a value measured in accordance with ASTM D2856.

The polyurethane foam panel according to the present invention is obtained by mixing a polyol composition containing one or more polyol compounds and a water as a foaming agent with a polyisocyanate component, and causing these components to react with each other.

In the present invention, the polyol composition preferably contains, as the polyol compound(s), a polyether polyol (A) that is a polymer having an average functional group number of 2 to 4 and a weight-average molecular weight of 3000 to 8000 and made from an alkylene oxide, and a short glycol (B) having a molecular weight less than 250.

The polyether polyol (A) is a polyoxyalkylene polyol yielded by causing an alkylene oxide to undergo ring-opening addition polymerization to an initiator having 2 to 4 active hydrogen atoms. Specific examples of the initiator include aliphatic polyhydric alcohols (for example, glycols such as ethylene glycol, propylene glycol, diethylene glycol, dipropylene glycol, 1,4-butanediol, 1,3-butanediol, 1,6-hexanediol, neopentyl glycol, cyclohexylene glycol and cyclohexanedimethanol, triols such as trimethylolpropane and glycerin, and tetrafunctional alcohols such as pentaerythritol; aliphatic amines (for example, alkylenediamines such as ethylenediamine, propylenediamine, butylenediamine, hexamethylenediamine and neopentyldiamine, and alkanolamines such as monoethanolamine and diethanolamine); and aromatic amines (for example, 2,4-toluenediamine, 2,6-toluenediamine, diethyltoluenediamine, 4,4′-diaminodiphenylmethane, p-phenylenediamine, o-phenylenediamine and naphthalenediamine). These compounds may be used alone or in any combination of two or more thereof. The initiator is preferably an aliphatic alcohol, more preferably a triol, even more preferably glycerin. About the polyether polyol (A), the average functional group number is from 2 to 4, more preferably from 2.5 to 3.5. About the polyether polyol (A), the weight-average molecular weight thereof is more preferably from 3000 to 5000.

Examples of the alkylene oxide include ethylene oxide, propylene oxide, 1,2-butylene oxide, 2,3-butylene oxide, styrene oxide, and cyclohexene oxide. It is preferred to use, out of these compounds, ethylene oxide and propylene oxide together, and cause these oxides to undergo ring-opening addition polymerization to the initiator. At this time, it is preferred to set the proportion of ethylene oxide (“ethylene oxide”/“ethylene oxide” +“propylene oxide”) into the range of 5 to 30%.

The hydroxyl value of the polyether polyol (A) is preferably from 20 to 100 mgKOH/g, more preferably from 30 to 60 mgKOH/g. If this hydroxyl value is less than 20 mgKOH/g, the viscosity ratio of the polyol composition to the polyisocyanate component is high so that when this composition is mixed with the polyisocyanate component, a stirring failure is caused. Conversely, if the value is more than 100 mgKOH/g, an appropriate toughness is not easily given to the resultant polyurethane foam. The hydroxide value is a value measured in accordance with JIS K1557-1:2007.

Examples of the short glycol (B), which has a molecular weight less than 250, include ethylene glycol (molecular weight: 62), propylene glycol (molecular weight: 76), diethylene glycol (molecular weight: 106), dipropylene glycol (molecular weight: 134), 1,4-butanediol (molecular weight: 90), 1,3-butanediol (molecular weight: 90), 1,6-hexanediol (molecular weight: 118), glycerin (molecular weight: 92), and tripropylene glycol (molecular weight: 192). Of these examples, preferred are diethylene glycol, dipropylene glycol and glycerin, and particularly preferred is diethylene glycol in order to make the foam high in resin strength with a higher certainty. The molecular weight of the short glycol (B) is preferably from 62 to 200 mgKOH/g, more preferably from 90 to 150 mgKOH/g.

The polyol composition used in the present invention for a polyurethane foam preferably contains, as the polyol compound(s), a polyether polyol (C) having an average functional group number of 2 to 4 and a weight-average molecular weight of 3000 to 5000 and made from propylene oxide. The polyether polyol (C) is a polyoxyalkylene polyol obtained by causing only propylene oxide to undergo ring-opening addition polymerization to an initiator having 2 to 4 active hydrogen atoms. Examples of the initiator include above-mentioned aliphatic polyhydric alcohols, aliphatic amines, and aromatic amines. However, the initiator is not particularly limited. The initiator is in particular preferably glycerin.

The polyol composition used as one of the raw materials in the present invention preferably contains 10 to 80 parts by weight of the polyether polyol (A) and 10 to 60 parts by weight of the short glycol (B) in 100 parts by weight of the polyol compound(s), and more preferably contains 15 to 70 parts by weight of the polyether polyol (A) and 10 to 50 parts by weight of the short glycol (B) therein in order to attain the production of a polyurethane foam panel excellent in heat insulating performance while the panel is made low in density. When the polyol composition contains the polyether polyol (C), the composition preferably contains 10 to 30 parts by weight of the polyether polyol (A), 10 to 60 parts by weight of the short glycol (B) and 30 to 70 parts by weight of the polyether polyol (C), and more preferably contains 15 to 25 parts by weight of the polyether polyol (A), 10 to 50 parts by weight of the short glycol (B) and 40 to 60 parts by weight of the polyether polyol (C).

Water is blended as a foaming agent into the polyol composition. The foaming agent is preferably water alone. The blend amount thereof is from 20 to 100 parts by weight for 100 parts by weight of the polyol compound (s), more preferably from 30 to 90 parts by weight therefor, even more preferably from 40 to 80 parts by weight therefor. Such a blend of water in a large amount makes it possible to make the polyurethane foam panel low in density.

Usually, a flame retardant, a catalyst and a foam adjustor are further blended into the polyol composition. Moreover, thereinto may be further blended a colorant, an antioxidant, and various other additives blendable into any polyol composition for a polyurethane foam.

Examples of the flame retardant include organic phosphates, halogen-containing compounds, and metal compounds such as aluminum hydroxide. Particularly preferred are organic phosphates since the compounds have an effect of lowering the viscosity of the polyol composition. Examples of the organic phosphates include halogenated alkyl esters of phosphoric acid, alkyl esters of phosphoric acid, aryl esters of phosphoric acid, and phosphonates. Specific examples thereof include tris(chloropropyl) phosphate (TMCPP, manufactured by Daihachi Chemical Industry Co., Ltd.), tributoxyethyl phosphate (TBEP), tributyl phosphate, triethyl phosphate, trimethyl phosphate, and cresyldiphenyl phosphate. The blend amount of the flame retardant is preferably from 10 to 50 parts by weight, more preferably from 15 to 40 parts by weight for 100 parts by weight of the polyol compound(s). It is particularly preferred that the polyol composition contains the flame retardant in an amount of 20 parts or more by weight for 100 parts by weight of the polyol compound(s), besides the polyether polyol (A) and the short glycol (B), since the brittleness-deterioration of the foam can be prevented.

The catalyst is not particularly limited as far as the catalyst is a catalyst for promoting the urethanizing reaction. The catalyst is preferably a reactive amine catalyst, which can react with isocyanate groups of the polyisocyanate component. Examples of the reactive amine catalyst include N,N-dimethylethanolamine, N, N-dimethylaminoethoxyethanol, N,N, N′ -trimethylaminoethylethanolamine, N,N,N′,N′-tetramethyl-2-hydroxypropylenediamine,

N-hydroxyethylmorpholine, N-methyl-N-hydroxyethylpiperazine, and N,N-dimethylpropylenediamine.

An ordinary tertiary amine catalyst is also usable. Examples of the tertiary amine catalyst include

N,N,N′,N′-tetramethylethylenediamine, N,N,N′,N′-tetramethylhexamethylenediamine, N,N,N′,N′,N″-pentamethyldiethylenetriamine, diazabicycloundecene, N,N-dimethylcyclohexylamine, triethylenediamine, and N-methylmorpholine.

The blend amount of the catalyst is preferably from 2 to 10 parts by weight, more preferably from 3 to 8 parts by weight for 100 parts by weight of the polyol compound(s).

The foam adjustor may be, for example, the following out of known foam adjustors for a polyurethane foam: a graft copolymer made from a polyoxyalkylene glycol, which is a polymer made from ethylene oxide or propylene oxide, and a polydimethylsiloxane. The foam adjustor is preferably a silicon foam adjustor in which the content by percentage of oxyethylene groups in a polyoxyalkylene is from 70 to 100% by mole. Specific examples thereof include products SH-193, SF-2937F and SF-2938F (manufactured by Dow Corning Toray Co., Ltd.), B-8465, B-8467 and B-8481 (manufactured by Evonik

Degussa Japan Co., Ltd.), and L-6900 (manufactured by the company Momentive). The blend amount of the foam adjustor is preferably from 1 to 10 parts by weight for 100 parts by weight of the polyol compound(s).

The polyisocyanate component, which is mixed with the polyol composition to be caused to react therewith, thereby producing a polyurethane foam panel, may be a polyisocyanate compound that has two or more isocyanate groups and that may be of various types, such as an aromatic, alicyclic and aliphatic types. The polyisocyanate component is preferably a liquid diphenylmethane diisocyanate (MDI) since this compound is easy to handle, is large in reaction rate and is low in costs, gives a polyurethane foam excellent in physical properties, and produces other advantages. Examples of the liquid MDI include crude MDIs (c-MDIs) “44V-10, 44V-20, etc.” (manufactured by Sumitomo Bayer Urethane Co., Ltd.), “MILLIONATE MR-200” (manufactured by Nippon Polyurethane Industry Co., Ltd.,), and urethonimine-containing MDIs “MILLIONATE MTL” (manufactured by Nippon Polyurethane Industry Co., Ltd.,). Together with the liquid MDI, a different polyisocyanate compound may be used. As the polyisocyanate compound used together therewith, a polyisocyanate compound known in the technical field of polyurethanes is usable without any restriction.

When the polyisocyanate component is mixed with the polyol composition to be caused to react therewith for the polyurethane foam panel according to the present invention, the isocyanate index (NCO index) is set preferably to 30 or less, more preferably to less than 30. The lower limit of the isocyanate index is, for example, 20. By setting the isocyanate index into the range, the polyurethane foam panel can be rendered a panel low in density and excellent in softness/flexibility and heat insulating performance. The isocyanate index herein denotes an index representing, in the unit of percentage, the ratio by equivalent of isocyanate groups of the polyisocyanate component to all active hydrogen groups (provided that a calculation therefor is made under a condition that water as the foaming agent is regarded as a bifunctional active hydrogen compound) contained in the polyol composition (the ratio of the equivalent of the isocyanate groups to 100 equivalents of the active hydrogen groups).

The polyurethane foam panel according to the present invention is preferably in accordance with, for example, the following production method:

A method for producing a hard polyurethane foam panel obtained by using, as raw materials therefor, a foaming stock solution composition which contains a polyol composition containing one or more polyol compounds and water as a foaming agent, and further which contains a polyisocyanate component, in which: the polyol composition contains, as the polyol compound(s), for example, polyol compounds including a polyether polyol (A) that is a polymer made from an alkylene oxide and has an average functional group number of 2 to 4 and a weight-average molecular weight of 3000 to 8000, and a short glycol (B) having a molecular weight less than 250; water is contained in an amount of 20 to 100 parts by weight for 100 parts by weight of the polyol compound (s); and when the polyisocyanate component is mixed with the polyol composition to be caused to react therewith, the isocyanate index is less than 30. In order to produce a polyurethane foam panel about which the thickness direction of the panel is substantially perpendicular to a foaming direction of cells in a foam of the panel, it is preferred to use a production method having an injecting step of injecting the foaming stock solution composition into a mold having a longitudinal direction, a widthwise direction and a thickness direction to make a side surface of the mold that extends the widthwise direction and the thickness direction consistent with the bottom surface of the resultant; and a reacting step of subjecting the foaming stock solution composition to reaction after the injecting step.

As illustrated in FIG. 3, in a conventional method for producing a polyurethane foam panel, a foaming stock solution composition containing a polyol composition and a polyisocyanate component is injected from a mixing head 1 onto a surface material 3 while the surface material 3 is wound from an original cloth thereof (injecting step). After the injecting step, the foaming stock solution composition is subjected to reaction while the foaming stock solution composition is covered with another surface material (rear surface material) 4 (reaction step). As a result, a polyurethane foam panel is obtained which has a foaming direction parallel with the thickness direction. In the polyurethane foam panel that is, particularly, a panel low in density, its individual cells are continuous bubbles, so that heat is largely shifted therein in the foaming direction. Thus, the panel tends to be lowered in heat insulating performance in the direction. For this reason, according to the conventional method for producing a polyurethane foam panel, the panel tends to be deteriorated in heat insulating performance in the thickness direction.

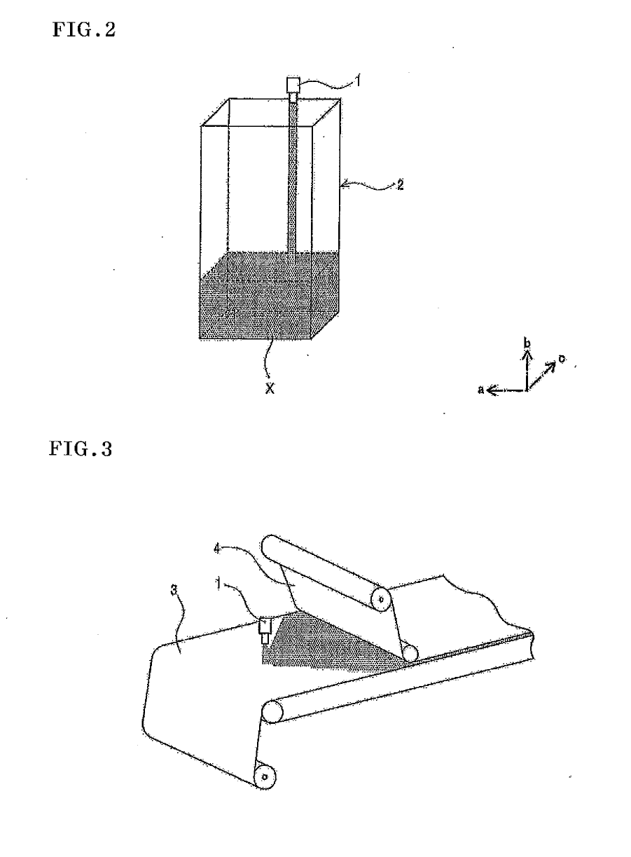

However, in the method according to the present embodiment for producing a polyurethane foam panel, as illustrated in, for example, FIG. 2, from a mixing head 1, a foaming stock solution composition containing a polyol composition and a polyisocyanate component is injected into a mold 2 having a lengthwise direction (longitudinal direction) “b”, a widthwise direction “a” and a thickness direction “c” to make a side surface of the mold that extends into the widthwise direction “a” and the thickness direction “c” consistent with the bottom surface X of the resultant (injecting step). After the injection, while the foaming stock solution composition undergoes reaction to be foamed (expanded) into the lengthwise direction “b”, a foam is formed (reaction step). As a result, a polyurethane foam panel is obtained in which the foaming direction (lengthwise direction “b”) is substantially perpendicular to the thickness direction “c”. In the reaction step, the mold may be wholly or locally heated as required.

Alternatively, the polyurethane foam panel may be produced by the following method, which is not illustrated: a method of spraying the same foaming stock solution composition onto a conveyer, and then cutting the resultant polyurethane foam panel into the form of a rectangular parallelepiped to make the vertical direction, the advancing direction of the conveyer and the widthwise direction of the conveyer consistent with the panel lengthwise direction, the panel widthwise direction and the panel thickness direction, respectively. Also in this case, the obtained polyurethane foam panel is a panel in which the foaming direction (lengthwise direction) is substantially perpendicular to the thickness direction.

The polyurethane foam panel according to the present invention is useful as a heating insulating member for various buildings, such as wooden houses, steel houses, factory buildings, and facilities, particularly, as a heating insulating member for being fitted to between frames that these buildings each have.

### EXAMPLES

Hereinafter, the present invention will be described in more detail by way of examples thereof. However, the present invention is not limited to these examples.

### Preparation of Polyol Compositions

A formulation shown in Table 1 described below was used as raw materials for a polyurethane foam panel to prepare each polyol composition. Details of the individual components in Table 1 are as follows:

### (1) Polyol Compounds

Polyether polyol (A)-1: trade name “EXCENOL-820” (manufactured by Asahi Glass Co., Ltd.), i.e., a polyether polyol (weight-average molecular weight=4900; hydroxyl value (OHV)=34 mgKOH/g) obtained by addition-polymerizing ethylene oxide and propylene oxide, using glycerin as an initiator,

Polyether polyol (A)-2: trade name “EXCENOL-850” (manufactured by Asahi Glass Co., Ltd.), i.e., a polyether polyol (weight-average molecular weight=7000; hydroxyl value (OHV)=25 mgKOH/g) obtained by addition-polymerizing ethylene oxide and propylene oxide, using glycerin as an initiator,

Short glycol (B)-1: diethylene glycol (DEG) (manufactured by Nacalai Tesque, Inc.; molecular weight=106, and hydroxyl value (OHV)=1058 mgKOH/g), and

Polyether polyol (C): trade name “T-3000S” (manufactured by Mitsui Chemicals, Inc.), i.e., a polyether polyol (weight-average molecular weight=3000; hydroxyl value=56 mgKOH/g) obtained by addition-polymerizing only propylene oxide, using glycerin as an initiator.

### (2) Flame Retardant

trade name “TMCPP” (manufactured by Daihachi Chemical Industry Co., Ltd.)

### (3) Foam Adjustor

Foam-adjustor-1: silicone nonionic surfactant, i.e., trade name “SF-2938F” (manufactured by Dow Corning Toray Co., Ltd.)

### (4) Catalysts

Catalyst-1: tertiary amine catalyst, i.e., trade name “TOYOCAT-ET” (manufactured by Toso Co., Ltd.), and

Catalyst-2: N, N-dimethylaminoethoxyethanol, i.e., trade name “KAO No. 26” (manufactured by Kao Corp.).

### Panel Evaluation

### Examples 1 to 3

Using a polyol composition prepared to have a composition described in Table 1, and a polyisocyanate component (c-MDI (“SUMIDULE 44V-10”, manufactured by Sumitomo Bayer Urethane Co., Ltd.); NCO%: 31%) (in each of these examples), a foaming stock solution composition was prepared which had an isocyanate index (NCO index) adjusted as described in Table 1. This composition was injected from the mixing head 1 onto the bottom surface X of the mold shown in FIG. 2 (the widthwise direction “a” length: 500 mm; the lengthwise direction “b” length: 900 mm; and the thickness direction “c” length: 500 mm). Thereafter, a polyurethane foam panel obtained by subjecting the foaming stock solution composition to reaction was cut into pieces along the thickness direction “c”. In this way, polyurethane foam panels were produced about each of which the panel thickness direction was substantially perpendicular)(90° to the foaming direction of in-foam cells of the panel (the panel widthwise direction “a”: 400 mm; the panel lengthwise direction “b” length: 700 mm; and the panel thickness direction “c” length: 60 mm). Results thereabout are shown in Table 1.

### Weight-Average Molecular Weight

The weight-average molecular weight (of any polymer in each of the examples) was obtained by making a measurement therefor by GPC (gel permeation chromatography) and then calculating out a value in terms of that of standard polystyrene.

GPC apparatus: LC-10A, manufactured by Shimadzu Corp.

Columns: the use of the following three columns linked to each other: columns (PLgel, 5 μm, 500 A), (PLgel, 5 μm, 100 Å) and (PLgel, 5 μm, 50 Å) manufactured by Polymer Laboratories Ltd.

Flow rate: 1.0 mL/min.

Concentration: 1.0 g/L

Injected amount: 40 μL

Column temperature: 40° C.

Eluent: Tetrahydrofuran

### Foam Density

The foam density (of the example) was obtained in accordance with JIS K 7222.

### Thermoconductivity

The thermoconductivity of the panel (of the example) in the thickness direction was measured in accordance with JIS A1412-2 (Method for Measuring Thermal Resistance and Thermoconductivity of Heat Insulating Material—Section 2: Heat Flow Meter Method) (HFM method) on the basis of JIS A9526 (Spray-Applied Rigid Urethane Foam for Thermal Insulation for Buildings).

### 10% Compressive Strength

A cube 50 millimeters square was cut out as a foam specimen from a central region of the polyurethane foam panel (the panel widthwise direction “a” length: 400 mm; the panel lengthwise direction “b” length: 700 mm; and the panel thickness direction “c” length: 60 mm) produced by the above-mentioned method (in each of the examples) (the central region: a region extended from the center of the panel in the widthwise direction and the lengthwise direction to both sides thereof along the former direction by 10% of the width, as well as to both sides thereof along the latter direction by 10% of the length). An autograph, AG-X plus (manufactured by Shimadzu Corp.) was used to measure the 10% compressive strength of the specimen at a compression rate of 5 mm/min.

### Fitting Workability of Each Polyurethane Foam Panel for Being Fitted into Predetermined Shape

When the panel (of each of the examples), 400 mm in width, was compressed into the widthwise direction by 5% to be easily fittable to between frames 380 mm in width, the panel was judged to have a flexibility for the predetermined width. Thus, this polyurethane foam panel was judged to be good in fitting workability (◯ in the table).

TABLE 1

| | | OHV | Exam- | Exam- | Exam- |
|---|---|---|---|---|---|
| Blend agents | | (mgKOH/g) | ple 1 | ple 2 | ple 3 |
| Polyether polyol | EX-820 | 34 | 70 | 20 | — |
| (A)-1 | | | | | |
| Polyether polyol | EX-850 | 25 | — | — | 80 |
| (A)-2 | | | | | |
| Polyether polyol | T-3000S | 56 | — | 70 | — |
| (C) | | | | | |
| Short glycol | DEG | 1058 | 30 | 10 | 20 |
| (B)-1 | | | | | |

| Flame retardant | | 50 | 40 | 50 |
|---|---|---|---|---|
| Foam-adjustor-1 | | 5.0 | 5.0 | 5.0 |
| Catalyst-1 | | 3.0 | 3.0 | 3.0 |
| Catalyst-2 | | 3.0 | 3.0 | 3.0 |
| Water | | 80.0 | 60.0 | 70.0 |
| Polyisocyanate | (NCO %) | (31%) | (31%) | (31%) |
| component | (NCO INDEX) | 27 | 22 | 30 |
| 10% Compressive | Lengthwise direction Sa | 1.12 | 0.95 | 1.01 |
| strength (N/cm²) | Widthwise direction Sb | 0.35 | 0.20 | 0.13 |
| | (Sa)/(Sb) | 3.20 | 4.75 | 7.77 |

| | | | |
|---|---|---|---|
| Foam density (kg/m³) | 6.9 | 9.8 | 7.0 |
| Thermoconductivity (W/m · K) | 0.0380 | 0.0385 | 0.0382 |
| Fitting workability into predetermined shape | ◯ | ◯ | ◯ |

From the results in Table 1, it is understood that the polyurethane foam panel of each of Examples 1 to 3 is low in density and small in brittleness, and has an excellent heat insulating performance in the thickness direction. It is also understood that the panel has a difference in compressive strength between the lengthwise direction and the lateral direction, and further has an excellent softness/flexibility in the widthwise direction to be excellent also in fitting workability.

1. A polyurethane foam panel which is obtained by mixing a polyol composition comprising a polyol compound and a water as a foaming agent with a polyisocyanate component, and causing these components to react with each other, and which has a lengthwise direction, a widthwise direction, and a thickness direction, wherein the foam density is 15 kg/m³ or less, and the ratio of the 10% compressive strength Sa in the lengthwise direction to the 10% compressive strength Sb in the widthwise direction (Sa/Sb) is 2 or more.

2. The polyurethane foam panel according to claim 1, wherein the 10% compressive strength Sb in the widthwise direction is 3 N/cm² or less.

3. The polyurethane foam panel according to claim 1, wherein the thickness direction of the polyurethane foam panel is substantially perpendicular to a foaming direction of cells in a foam of the panel.
